(19) United States
(12) Patent Application Publication
(10) Pub. No.: US 2026/0159731 A1
(43) Pub. Date: Jun. 11, 2026

(54) SEALANT COMPOSITION FOR MULTI-PANE INSULATION GLASS

(71) Applicant: SAS CHEMICALS GMBH, Moers (DE)

(72) Inventors: Süleyman Kaya, Moers (DE); Salih Arisüt, Istanbul (TR)

(21) Appl. No.: 19/124,413

(22) PCT Filed: Oct. 24, 2023
(86) PCT No.: PCT/DE2023/100790

§ 371 Date: Apr. 25, 2025

(30) Foreign Application Priority Data
Oct. 25, 2022 (DE) 10 2022 128 190.6

(51) Int. Cl. C09J 109/00; B32B 3/08; B32B 7/12; B32B 17/10; C03C 27/10; C09J 11/04; C09J 11/06; C09J 123/08; C09J 157/00

(52) U.S. Cl. CPC C09J 109/00; B32B 3/08; B32B 7/12; B32B 17/10; C03C 27/10; C09J 11/04; C09J 11/06; C09J 123/0853; C09J 157/00; B32B 2255/26; B32B 2307/304

(57) ABSTRACT

The invention relates to a sealant composition for the manufacture of multi-pane insulation glass which is characterized by its composition.

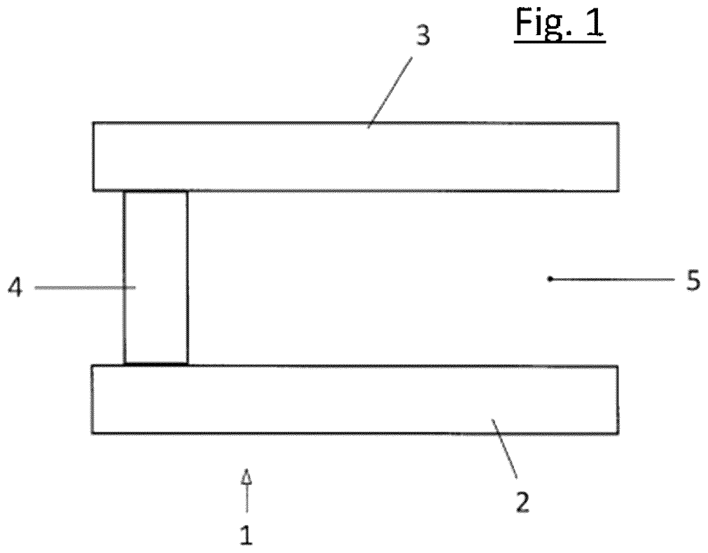

### The invention relates to a sealant composition for a multi-pane insulating glass.

Multi-pane insulating glass is well known. It consists of two or more parallel glass panes that are joined at their edges to prevent moisture from entering the space between the panes and to seal them against the ambient air. An important objective is therefore to prevent moisture from entering and gas from escaping from the space between the panes. A technology using spacers made of aluminum or other metals is essentially a thing of the past. Thereby, a sealant, often polyisobutylene or butyl rubber, is located between the surfaces of the spacer facing the glass panes and the glass surface. Instead of prefabricated metal profiles, prefabricated thermoplastic or plastic profiles or materials extruded directly onto the glass panes are therefore used. However, the mechanical cohesion of such panes deteriorates even under stress from weather influences, etc., with the risk of mechanical or chemical damage.

Based on this state of the art, the present invention sets itself the task of providing an improved sealant composition which is characterized by an optimization with regard to the penetration of moisture or the escape of gas.

This task is solved by a sealant composition comprising at least one of the following ingredients:
15.0 to 25.0% by weight of industrial carbon black grades
5.0 to 30.0% by weight of modified polymers
5.0 to 12% by weight of isobutylene isoprene rubber grades
3.0 to 10.0 wt % ethylene vinyl acetate
2.0 to 20.0 wt % calcium carbonate types
10.0 to 25.0 wt % zeolite
3.0 to 15.0 wt % aliphatic hydrocarbon resins
1.0 to 5.0 wt. % silanes (types 3a-10a)
1.0 to 5.0 wt. % rosin ester
1.0 to 5.0 wt. % catalysts, antioxidants, UV stabilizers

This creates a sealant composition based on the “all in one” principle that meets the highest demands in terms of external mechanical and/or chemical stresses. Such a sealant composition is preferably used in the manufacture of multi-pane insulating glass, whereby all components used in the manufacture of insulating glass such as primary sealant, secondary sealant, spacers and/or desiccants, including flexible spacers with integrated desiccant, are used in a single thermoplastic form.

In addition to the sealing mentioned above, the sealant composition according to the invention is very advantageous in many respects. For example, the panes can be sealed with just one component, which reduces storage requirements and storage costs.

It is no longer necessary to keep spacers in different sizes and dimensions, primary sealant, secondary sealant, or desiccants in stock. This also eliminates various tasks such as bending or cutting the spacers, butylating the spacers, and sealing with secondary sealant. Corner or longitudinal connectors are also no longer necessary.

This reduces the amount of work required, thereby lowering costs and enabling automation in just a few steps.

Another noteworthy feature is the reduced thermal conductivity of the multi-pane insulating glass thanks to the complete thermoplastic sealing of the panes—without the use of metal. This makes the multi-pane insulating glass of the present invention particularly environmentally friendly thanks to the reduced thermal conductivity of the sealant.

Condensation on the corners and edges of the panes is also greatly reduced. In addition, there is less gas loss.

The same applies to the reduced moisture inside the glass panes, which results in a longer service life. Better and longer-lasting adhesion also allows use with “all-in-one” panes, even in facade construction.

The fact that the sealant composition is used as a component of the composite for the manufacture of multi-pane insulating glass corresponds to its preferred application. This creates an “all-in-one” sealant composition that meets the highest demands in terms of external mechanical and chemical stresses.

Specifically, the sealant composition serves not only as a component, but as the sole component of the composite for the manufacture of multi-pane insulating glass. Thanks to the invention, multi-pane insulating glass composite systems can therefore be manufactured in a single-component manner.

Other applications are also conceivable.

An advantageous embodiment of the invention provides that the sealant composition serves as a primary sealant, secondary sealant, desiccant, and/or spacer, preferably as a spacer with integrated desiccant for the manufacture of multi-pane insulating glass, i.e., that the aforementioned functions are combined in the sealant according to the invention.

What is meant by the single-component production of multi-pane insulating glass composite systems becomes clear when it is stated that the multi-pane insulating glass contains individually sealed, hot-applicable adhesive compounds. Individually sealed adhesive compounds that cure with the humidity of the ambient air are used.

In this context, it is intended that the adhesive compounds contain a mixture of reactive and non-reactive binders.

This can be specified in such a way that a reactive binder is made from silane-functional polyisobutylene, silane-functional butyl rubber, silane-functional copolymer, silane-functional hydrogenated polybutadiene, and/or silane-functional poly-α-olefin. So far for the reactive binders.

As regards non-reactive binders, it is proposed that a non-reactive binder be derived from the group consisting of butyl rubber, poly-α-olefins, rosin esters, hydrocarbon resins, and rubbers based on copolymers.

In order to improve the quality of adhesion between the glass panes and the sealant, it is proposed that the edges of the glass panes be cleaned with a primary cleaner prior to application.

It is also proposed that the edges of the glass panes be surface-treated prior to application. Laser or plasma treatment is envisaged here.

The invention is characterized in particular by the fact that a sealant composition has been created that works according to the “all in one” principle, especially since multi-pane insulating glass composite systems can now be manufactured in a single component by using individually sealed, hot-applied adhesive compounds that cure with the humidity of the ambient air and contain a mixture of reactive and non-reactive binding agents.

Further details and advantages of the invention are apparent from the following description of the accompanying drawing, which shows a preferred embodiment with the necessary details and individual parts.

The single figure shows a schematic diagram of a double-pane insulating glass unit 1 consisting of two parallel glass panes 2, 3 and the space 5 between them. The sealant 4 is multifunctional in that it combines various functions. These include, for example, primary sealant, secondary sealant, spacer and desiccant.

1. A sealant composition comprising:
15.0 to 25.0 % by weight of carbon black grades;
5.0 to 30.0 % by weight of polymers modified;
5.0 to 12.0 % by weight isobutylene isoprene rubber grades;
3.0 to 10.0 % by weight ethylene vinyl acetate;
2.0 to 20.0 % by weight of calcium carbonate grades;
10.0 to 25.0 % by weight of zeolite grades (3a-10a);
3.0 to 15.0 % by weight of aliphatic hydrocarbon resins;
1.0 to 5.0 % by weight silanes;
1.0 to 5.0 % by weight of rosin ester; and
1.0 to 5.0 % by weight of at least one of catalysts, antioxidants, or stabilizers.

2. The sealant composition according to claim 1, wherein the sealant composition serves as a component of a composite in the manufacture of multi-pane insulating glass.

3. The sealant composition according to claim 2, wherein the sealant composition serves as the sole component of the composite for the production of multi-pane insulating glass.

4. The sealant composition according to claim 1, wherein the sealant composition serves as at least one of a primary sealant, a secondary sealant, a desiccant, or a spacer.

5. The sealant composition according to claim 2, wherein individually sealed, heat-applicable adhesive compositions are provided for producing the multi-pane insulating glass unit.

6. The sealant composition according to claim 5, wherein the individually sealed, heat-applicable adhesive sealant compositions contain a mixture of reactive and non-reactive binders.

7. The sealant composition according to claim 1, further comprising:
a reactive binder made from at least one of silane-functional polyisobutylene, silane-functional butyl rubber, silane-functional co-polymer, silane-functional hydrogenated polybutadiene, or silane-functional poly-α-olefin.

8. The sealant composition according to claim 1, further comprising:
a non-reactive binder derived from a group consisting of butyl rubber, poly-α-olefin polybutenes, rosin esters, hydrocarbon resins, or rubbers based on copolymers.

9. The sealant composition according to claim 2, wherein glass pane edges of panes of the multi-pane insulating glass are cleaned with a primary cleaner before application of the composite.

10. The sealant composition according to claim 2, wherein glass pane edges of panes of the multi-pane insulating glass are surface-treated before application of the composite.

11. The sealant composition according to claim 1, wherein the sealant composition serves as a spacer with integrated desiccant for the production of multi-pane insulating glass.

12. A multi-pane insulating glass, comprising:
a plurality of glass panes; and
a composite comprising a sealant composition including:
15.0 to 25.0 % by weight of carbon black grades;
5.0 to 30.0 % by weight of polymers modified;
5.0 to 12.0 % by weight isobutylene isoprene rubber grades;
3.0 to 10.0 % by weight ethylene vinyl acetate;
2.0 to 20.0 % by weight of calcium carbonate grades;
10.0 to 25.0 % by weight of zeolite grades (3a-10a);
3.0 to 15.0 % by weight of aliphatic hydrocarbon resins;
1.0 to 5.0 % by weight silanes;
1.0 to 5.0 % by weight of rosin ester; and
1.0 to 5.0 % by weight of at least one of catalysts, antioxidants, or stabilizers.

13. The multi-pane of claim 12, wherein the composite consists of the sealant composition.

14. The multi-pane of claim 12, wherein the sealant composition serves as at least one of a primary sealant, a secondary sealant, a desiccant, or a spacer.

15. The multi-pane of claim 12, wherein the sealant composition is provided in a plurality of individually sealed, heat-applicable adhesive compositions.

16. The multi-pane of claim 15, wherein the individually sealed, heat-applicable adhesive sealant compositions contain a mixture of reactive and non-reactive binders.

17. The multi-pane of claim 12, wherein the sealant composition further comprises:
a reactive binder made from at least one of silane-functional polyisobutylene, silane-functional butyl rubber, silane-functional co-polymer, silane-functional hydrogenated polybutadiene, or silane-functional poly-α-olefin.

18. The multi-pane of claim 12, wherein the sealant composition further comprises:
a non-reactive binder derived from a group consisting of butyl rubber, poly-α-olefin polybutenes, rosin esters, hydrocarbon resins, or rubbers based on copolymers.

19. The multi-pane of claim 12, wherein at least one of:
glass pane edges of the plurality of glass panes are cleaned with a primary cleaner before application of the composite; or
glass pane edges of the plurality of glass panes are surface-treated before application of the composite.

20. The multi-pane of claim 12, wherein the sealant composition serves as a spacer with integrated desiccant for the production of the multi-pane insulating glass.
